(19) United States
(12) Patent Application Publication
(10) Pub. No.: US 2025/0079523 A1
(43) Pub. Date: Mar. 6, 2025

(54) NON-AQUEOUS ELECTROLYTE AND BATTERIES CONTAINING THE SAME

(71) Applicant: EaglePicher Technologies, LLC, Joplin, MO (US)

(72) Inventor: Thomas James BARBARICH, North Kingstown, RI (US)

(21) Appl. No.: 18/817,063

(22) Filed: Aug. 27, 2024

Related U.S. Application Data
(60) Provisional application No. 63/534,928, filed on Aug. 28, 2023.

(51) Int. Cl. H01M 10/0568; H01M 10/0525; H01M 10/0567; H01M 10/0569

(52) U.S. Cl. CPC H01M 10/0568; H01M 10/0525; H01M 10/0567; H01M 10/0569; H01M 2300/0028

(57) ABSTRACT

A non-aqueous electrolyte for a lithium-ion cell includes a base electrolyte consisting of lithium hexafluorophosphate or lithium bis(fluorosulfonyl)imide or a combination thereof in methyl propionate; about 2 to about 15 parts by weight, preferably about 6 to about 15 parts by weight of vinylene carbonate; and about 0.5 to about 5 parts by weight, preferably about 2 to about 5 parts by weight of an additive comprising lithium difluorophosphate, lithium difluoro(oxalate)borate, lithium bis(oxalate)borate, or a combination thereof, wherein the content of the vinylene carbonate and the additive are each based on a total weight of the base electrolyte, the vinylene carbonate, and the additives.

### CROSS-REFERENCE TO RELATED APPLICATION

This application claims the benefit of U.S. Provisional Patent Application No. 63/534,928, filed Aug. 28, 2023, and hereby incorporates by reference herein the contents of this application.

### TECHNICAL FIELD

Aspects of the present disclosure relate to a non-aqueous electrolyte, and lithium-ion batteries including the non-aqueous electrolyte.

### BACKGROUND

Lithium-ion batteries are used in a wide variety of applications and temperature conditions. Therefore, it is advantageous for lithium-ion batteries to be able to perform in a wide variety of temperature conditions, ranging from ambient temperature conditions to low temperature conditions. For some applications, good performance at temperatures as low a −60° C. at moderately high discharge rates, while also having good cycle life at ambient temperature, is desired. However, it is difficult to obtain effective battery performance at temperatures below −40° C. because cold temperatures cause battery electrolytes to become more viscous, which lowers lithium ion conductivity, or to freeze, which inhibits the mobility of lithium ions entirely. Low temperatures can also make it more difficult to overcome the energy needed to desolvate solvents from the lithium ion thus lowering the performance.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

A non-aqueous electrolyte for a lithium-ion cell includes a base electrolyte consisting of lithium hexafluorophosphate or lithium bis(fluorosulfonyl)imide or a combination thereof in methyl propionate; about 2 wt % to about 15 wt %, preferably about 2 wt % to about 12 wt % of vinylene carbonate; and about 0.5 wt % to about 5 wt %, preferably about 2 wt % to about 5 wt % of an additive comprising lithium difluorophosphate, lithium difluoro(oxalate)borate, lithium bis(oxalate)borate, or a combination thereof.

A lithium-ion cell includes: a positive electrode; a negative electrode; a separator between the positive electrode and the negative electrode; and the above-described non-aqueous electrolyte.

A method of manufacturing a lithium-ion cell includes providing the above-described non-aqueous electrolyte; and adding the non-aqueous electrolyte to an assembly comprising a cathode, an anode, and a separator between the cathode and the anode to manufacture the lithium-ion cell.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a graph of capacity (milliampere-hours, mAh) at C/2 discharge rate at 25° C. prior to cycling, after 100 cycles, and after 200 cycles at 25° C. for cells with non-aqueous electrolytes having varying lithium difluorophosphate (LDFP) content of Examples 1, 3, 5, and 6 according to aspects of the present disclosure;

FIG. 2 is a graph of capacity (mAh) at C/4 discharge rate at −60° C. prior to cycling, after 100 cycles, and after 200 cycles at 25° C. for cells with non-aqueous electrolytes having varying LDFP content of Examples 1, 3, 5, and 6 according to aspects of the present disclosure;

FIG. 3 is a graph of the voltage (volt, V) at the end of a one second 1 C pulse at 95% state-of-charge (SOC) at −60° C. prior to cycling, after 100 cycles, and after 200 cycles at 25° C. for cells with varying LDFP content of Examples 1, 3, 5, and 6 according to aspects of the present disclosure;

FIG. 4 is a graph of capacity (mAh) at C/2 discharge rate at 25° C. prior to cycling, after 100 cycles, and after 200 cycles at 25° C. for cells with electrolytes with varying vinylene carbonate (VC) content of Examples 2-4 according to aspects of the present disclosure;

FIG. 5 is a graph of capacity (mAh) at C/4 discharge rate at −60° C. prior to cycling, after 100 cycles, and after 200 cycles at 25° C. for cells with electrolytes with varying VC content of Examples 2-4 according to aspects of the present disclosure;

FIG. 6 is a graph of the voltage (volts, V) at the end of a one second 1 C pulse at 95% SOC at −60° C. prior to cycling, after 100 cycles, and after 200 cycles at 25° C. for cells with electrolytes with varying VC content of Examples 2-4 according to aspects of the present disclosure;

FIG. 7 is a graph of capacity (mAh) at C/2 discharge rate at 25° C. prior to cycling, after 100 cycles, and after 200 cycles at 25° C. for cells with electrolytes having varying lithium difluoro(oxalato)borate (LiDFOB) content of Examples 7-9 and comparison to LDFP (Ex 3) and VC only without LIDFOB or LDFP (Ex 1) according to aspects of the present disclosure;

FIG. 8 is a graph of capacity (mAh) at C/4 discharge rate at −60° C. prior to cycling, after 100 cycles, and after 200 cycles at 25° C. for cells with electrolytes having varying LiDFOB content of Examples 7-9 and comparison to LDFP (Example 3) and VC only without LIDFOB or LDFP (Example 1) according to aspects of the present disclosure;

FIG. 9 is a graph of the voltage (volts, V) at the end of a one second 1 C pulse at 95% SOC at −60° C. prior to cycling, after 100 cycles, and after 200 cycles at 25° C. for cells with varying LiDFOB content of Examples 7-9 and comparison to LDFP (Example 3) and VC only without LIDFOB or LDFP (Example 1) according to aspects of the present disclosure;

FIG. 10 is a graph of capacity (mAh) at C/2 discharge rate at 25° C. prior to cycling, after 100 cycles, and after 200 cycles at 25° C. for cells with non-aqueous electrolytes with varying ethylene carbonate (EC) content of CEx 4 and CEx 5 and comparison to the non-aqueous electrolyte with no EC of Example 3 according to aspects of the present disclosure;

FIG. 11 is a graph of capacity (mAh) at C/4 discharge rate at −60° C. prior to cycling, after 100 cycles, and after 200 cycles at 25° C. for cells with electrolytes with varying EC content of CEx 4 and CEx 5 and comparison to the non-aqueous electrolyte with no EC of Example 3 according to aspects of the present disclosure;

FIG. 12 is a graph of the voltage (volts, V) at the end of a one second 1 C pulse at 95% SOC at −60° C. prior to cycling, after 100 cycles, and after 200 cycles at 25° C. for cells with varying EC content of CEx 4 and CEx 5 and comparison to the non-aqueous electrolyte with no EC of Example 3 according to aspects of the present disclosure;

FIG. 13 is a graph of capacity (mAh) at C/2 discharge rate at 25° C. prior to cycling, after 100 cycles, and after 200 cycles at 25° C. for cells with non-aqueous electrolytes containing the base electrolyte of Example 3 with additionally lithium bis(oxalato)borate (LiBOB) of varying amount, a salt solution with 0.1 M LiPF6 and 0.75 M lithium bis(fluorosulfonyl)imide (LiFSI) in methyl propionate (MP) with 3.8% VC and 1.9% LDPF, and comparison to the base electrolyte of Example 3 according to aspects of the present disclosure;

FIG. 14 is a graph of capacity (mAh) at C/4 discharge rate at −60° C. prior to cycling, after 100 cycles, and after 200 cycles at 25° C. for cells with non-aqueous electrolytes containing the base electrolyte of Example 3 with additionally LiBOB of varying amount, a salt solution with 0.1 M LiPF6 and 0.75 M LiFSI in MP with 3.8% VC and 1.9% LDPF, and comparison to the base electrolyte of Example 3 according to aspects of the present disclosure;

FIG. 15 is a graph of the voltage (volts, V) at the end of a one second 1 C pulse at 95% SOC at −60° C. prior to cycling, after 100 cycles, and after 200 cycles at 25° C. for cells with electrolytes containing the base electrolyte of Example 3 with additionally LiBOB of varying amount, a salt solution with 0.1 M LiPF6 and 0.75 M LiFSI in MP with 3.8% VC and 1.9% LDPF, and comparison to the base electrolyte of Example 3 according to aspects of the present disclosure;

FIG. 16 is a graph of the voltage (volts, V) versus capacity (ampere-hours, Ah) during discharge at 25° C. and at −60° C. for a 18650 cell with a non-aqueous electrolyte containing 0.85 M LiPF6 in MP with 8.9% VC and 1.8% LDFP according to aspects of the present disclosure; and

FIG. 17 is a graph of the voltage (V, volts) versus capacity (ampere-hours, Ah) during C/4 discharge rate at 20° C., −50° C., and −60° C. for an 8 Ah cell with the non-aqueous electrolyte of Example 3 and the electrolyte of Example 4 according to aspects of the present disclosure;

FIG. 18 illustrates a schematic representation of an example battery cell according to aspects of the present disclosure;

FIG. 19 illustrates a method for preparing the non-aqueous electrolytes according to aspects of the present disclosure; and

FIG. 20 illustrates a method for preparing a lithium-ion cell including the non-aqueous electrolyte of FIG. 19 according to aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

The present disclosure is directed to a non-aqueous electrolyte that provides an unexpectedly improved combination of superior battery performance at low temperatures such as −60° C., while also providing good cycle life at ambient temperature. In contrast, conventional batteries become inoperable at temperatures below −20° C. Even conventional Li-ion batteries that are designed for low temperature performance have extremely limited performance at temperatures as low as −40° C., let alone as low as −60° C. The non-aqueous electrolyte described herein is effective at temperatures of at least 40° C. to −60° C. In some aspects, the non-aqueous electrolyte described herein is effective at temperatures of 25° C. to −60° C. In some aspects, the non-aqueous electrolyte is effective at temperatures between −60° C. to −60° C. In some aspects, the non-aqueous electrolyte is effective at temperatures at or below −40° C. or at or below −60° C. For example, at ambient and modestly elevated temperatures such as 40° C., cells with this nonaqueous electrolyte will have C/10 discharge capacity values at least 90% of the 25° C. capacity at C/10 rate with low capacity fade rate. The low temperature discharge capacity of cells including the non-aqueous electrolyte at −60° C. at a C/10 discharge rate is at least 25% of the discharge capacity at 25° C. at C/10 discharge. The effectiveness of a cell is dependent on cell design and applications, and what may be an acceptable in a particular cell may not be acceptable to another particular cell.

The non-aqueous electrolyte comprises a base electrolyte, about 2 wt % to about 15 wt % of vinylene carbonate, and about 1% to about 5% of an additive, wherein the contents of the vinylene carbonate and the additive are each based on a total weight of the base electrolyte, the vinylene carbonate, and the additive. The base electrolyte consists of a lithium salt such as lithium hexafluorophosphate or lithium bis(fluorosulfonyl)imide (LFSI) or combinations thereof dissolved in methyl propionate. Lithium hexafluorophosphate, lithium bis(fluorosulfonyl)imide, or a combination thereof can be present in an amount of about 0.3 to about 1.5 mole/liter (M), about 0.6 to about 1.2 M, or about 0.7 to about 1 M in the base electrolyte.

The vinylene carbonate can be present in an amount of about 2 wt % to about 15 wt %, preferably about 2 wt % to about 12 wt % parts by weight, more preferably about 3 wt % to about 10 wt %.

In some aspects, the additive comprises lithium difluorophosphate, lithium difluoro(oxalato)borate, lithium bis(oxalato)borate, or a combination thereof. In some aspects, the additive comprises lithium difluorophosphate. In some aspects, the additive comprises lithium difluoro(oxalate)borate. In some aspects, the additive comprises lithium bis(oxalato)borate. As described in greater detail below, lithium difluorophosphate improves battery discharge capacity at low temperatures. The improvement to battery discharge capacity provided by lithium difluorophosphate increases as the temperature decreases. The improvement to battery discharge capacity provided by lithium difluorophosphate is particularly relevant at temperatures at or below −40° C., at or below −60° C., and/or −40° C. to −60° C. As described in greater detail below, lithium difluoro(oxalato)borate and/or lithium bis(oxalato)borate may improve battery discharge at temperatures at or below −40° C., at or below −60° C., and/or −40° C. to −60° C. In some aspects, lithium difluoro(oxalato)borate and lithium bis(oxalato)borate may add stability to higher temperature cycling, for example at temperatures at or above ambient temperature. In some aspects, lithium difluoro(oxalato)borate may add low temperature discharge performance and may improve higher temperature stability.

In some aspects, the additive consists of lithium difluorophosphate, lithium difluoro(oxalato)borate, lithium bis(oxalato)borate, or a combination thereof. In some aspects, the additive consists of lithium difluorophosphate. In some aspects, the additive consists of lithium difluoro(oxalate)borate. In some aspects, the additive consists of lithium bis(oxalato)borate. In some aspects, the additive is selected from the group consisting of lithium difluorophosphate, lithium difluoro(oxalato)borate, lithium bis(oxalato)borate, or a combination thereof.

The additive is contained in an amount of about 0.5 wt % to about 5 wt %, about 1 wt % to about 5 wt %, preferably about 2 wt % to about 5 wt %, more preferably about 1 wt % to about 3 wt % or about 1.5 wt % to about 2.5 wt %.

The non-aqueous electrolyte can comprise less than about 10 wt %, less than about 3 wt %, or less than about 1 wt % of an ethylene carbonate (EC). n an embodiment, the non-aqueous electrolyte is substantially free from EC. As used herein, the phrase “substantially free from” means that the non-aqueous electrolyte does not include more than 1 wt % of EC.

As a specific example, the non-aqueous electrolyte comprises a base electrolyte, vinylene carbonate, and an additive. The base electrolyte comprises about 0.3 to about 1.5 M, about 0.6 to about 1.2 M, or about 0.7 to about 1 M lithium hexafluorophosphate or a lithium hexafluorophosphate and lithium bis(fluorosulfonyl)imide mixture in methyl propionate. The non-aqueous electrolyte comprises about 2 wt % to about 15 wt %, about 2 wt % to about 12 wt %, preferably about 3 wt % to about 10 wt % vinylene carbonate. The non-aqueous electrolyte comprises about 0.5 wt % to about 5 wt %, or about 2 wt % to 5 wt % of an additive comprising lithium difluorophosphate, lithium difluoro(oxalate)borate, lithium bis(oxalato)borate, or a combination thereof.

As a specific example, the non-aqueous electrolyte consists of a base electrolyte, vinylene carbonate, and an additive. The base electrolyte consists of about 0.3 to about 1.5 M, about 0.6 to about 1.2 M, or about 0.7 to about 1 M lithium hexafluorophosphate or a lithium hexafluorophosphate and lithium bis(fluorosulfonyl)imide mixture in methyl propionate. The non-aqueous electrolyte consists of about 2 wt % to about 15 wt %, preferably about 2 wt % to about 12 wt %, or about 3 to about 10 wt % of vinylene carbonate. The non-aqueous electrolyte consists of about 0.5 wt % to about 5 wt %, or about 2 wt % to 5 wt % of an additive including lithium difluorophosphate, lithium difluoro(oxalate)borate, lithium bis(oxalato)borate, or a combination thereof.

The non-aqueous electrolyte can be prepared by combining the base electrolyte with vinylene carbonate and the additive. For example, vinylene carbonate and the additive can be added to the base electrolyte separately or in combination.

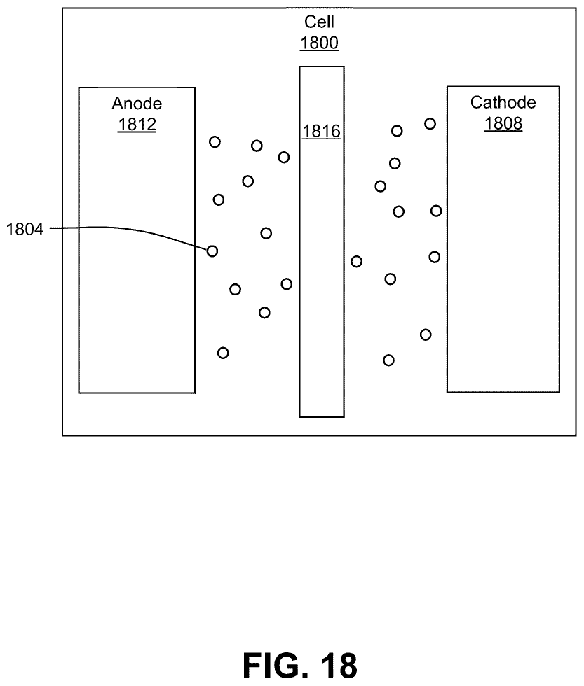

FIG. 18 illustrates a schematic representation of an example cell 1800. In an aspect, the cell 1800 includes a lithium-ion cell, e.g., of lithium-ion battery, the cell 1800 comprises the non-aqueous electrolytes (shown schematically as 1804) described herein. The cell 1800 includes a cathode 1808; an anode 1812; a separator 1816 between the cathode 1808 and the anode 1812; and the above-described non-aqueous electrolyte. A ratio of an amount of the vinylene carbonate (VC) in grams in the non-aqueous electrolyte relative to an initial capacity of the lithium-ion cell that comprises the non-aqueous electrolyte in ampere-hour can be between about 0.1 g VC to 1 Amp-hour initial capacity and about 1 g VC to 1 amp hour initial capacity. The initial capacity is the first discharge capacity of the cell which is determined at a rate of discharge of about C/10. The initial capacity is roughly correlated to the electrode surface area. A C-rate is a measure of the rate a cell is charged or discharged relative to the cell's rated capacity at ambient temperature, and is obtained by dividing a total capacity of the cell by a total discharge period of time. A 1 C-rate means a current which will discharge the entire capacity in one hour. For example, for a cell with a capacity of 100 ampere-hrs, a C-rate discharge would be a discharge current of 100 amperes, a 5 C rate for this battery would be 500 amperes, a C/10 rate would be 10 amperes, and a C/4 rate would be 25 amperes.

The cathode 1808 comprises a positive active material, which is not particularly limited. Preferably, the cathode comprises, as an active material, lithium manganese oxide (LMO), lithium nickel manganese oxide (LNMO), lithium nickel cobalt manganese oxide (NMC), lithium nickel cobalt aluminum oxide (NCA), lithium nickel cobalt oxide (LCO), lithium iron phosphate (LFP), lithium manganese iron phosphate (LMFP), or a combination of thereof. The cathode may comprise a current collector. The current collector for the cathode may comprise aluminum.

The anode 1812 may comprise a negative active material, such as graphite, hard carbon, silicon, or a combination thereof.

The anode 1812 may comprise a current collector. The current collector for the anode may comprise copper.

The cathode 1808 and the anode 1812 may each independently further comprise a binder or a conductive agent.

The cell 1800 can comprise one or more binders such as polyvinylidene difluoride, polyvinyl alcohol, carboxymethyl cellulose, starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, or a copolymer thereof. A combination comprising at least one of the foregoing binders may be used.

The cell 1800 can comprise one or more conductive agents such as ketjen black, carbon black, graphite, carbon nanotubes, carbon fiber, mesoporous carbon, mesocarbon microbeads, oil furnace black, extra-conductive black, acetylene black, lamp black, or a combination thereof.

The cell 1800 comprises a microporous separator 1816 disposed between the cathode 1808 and the anode 1812. A microporous polyolefin membrane made of polypropylene, polyethylene, or a copolymer thereof, may be used as the separator 1816.

The cell 1800 may be manufactured by providing the non-aqueous electrolyte 1804 and adding the non-aqueous electrolyte 1804 to an assembly comprising the cathode 1808; the anode 1812; and the separator 1816 between the cathode 1808 and the anode 1812.

The battery including the disclosed non-aqueous electrolyte may provide improved capacity retention at low temperatures compared to a battery including a non-aqueous electrolyte containing ethylene carbonate. Such low temperatures may include temperatures at or below −40° C., temperatures at or below −60° C., and/or temperatures from −40° C. to −60° C.

For the battery including the non-aqueous electrolyte as described herein, the percentage of the capacity obtained at −60° C. with a C/4 discharge rate compared to the capacity obtained at 25° C. with a C/2 discharge rate may be 50% or greater even after aging the cell by cycling the cell at 25° C. with full depth-of-discharge (DoD) for 200 cycles. For example, the −60° C. discharge capacity retention following a 25° C. charge may be greater than 50% or greater than 60% of the beginning-of-life 25° C. capacity after cell aging with 200 cycles of charge and discharge at 25° C. at 100% DoD (full state-of-charge to about 2.5 V) at 25° C. at a 0.5° C. rate.

The battery including the non-aqueous electrolyte may also have good discharge capacity retention at ambient temperature after cycling comparable to a battery that contains EC which is a traditional electrolyte component that is traditionally considered necessary for good cycle life. For example, the battery including the non-aqueous electrolyte as described herein, has a 25° C. discharge capacity retention after aging with 200 cycles of charge and discharge at full DoD at a constant current of 0.5 C rate may be 80% or greater. For example, a good cycle life for a battery having a lithium nickel cobalt aluminum oxide (NCA) anode and a graphite cathode and including the non-aqueous electrolyte as described herein, has a 25° C. discharge capacity retention after aging with 200 cycles of charge and discharge at full DoD at a constant current of 0.5 C rate may be 90% or greater. In some aspects, the discharge capacity retention may be greater than about 90% of the capacity obtained at 25° C. with a 0.5° C. rate at the beginning-of-life, so the battery the battery including the non-aqueous electrolyte as described herein only loses 10% of capacity after aging with 200 cycles of charge and discharge. In some aspects, the discharge capacity retention may be greater than about 80% of the capacity obtained at 25° C. with a 0.5 C rate at the beginning-of-life, so the battery the battery including the non-aqueous electrolyte as described herein only loses 20% or capacity after aging with 200 cycles of charge and discharge.

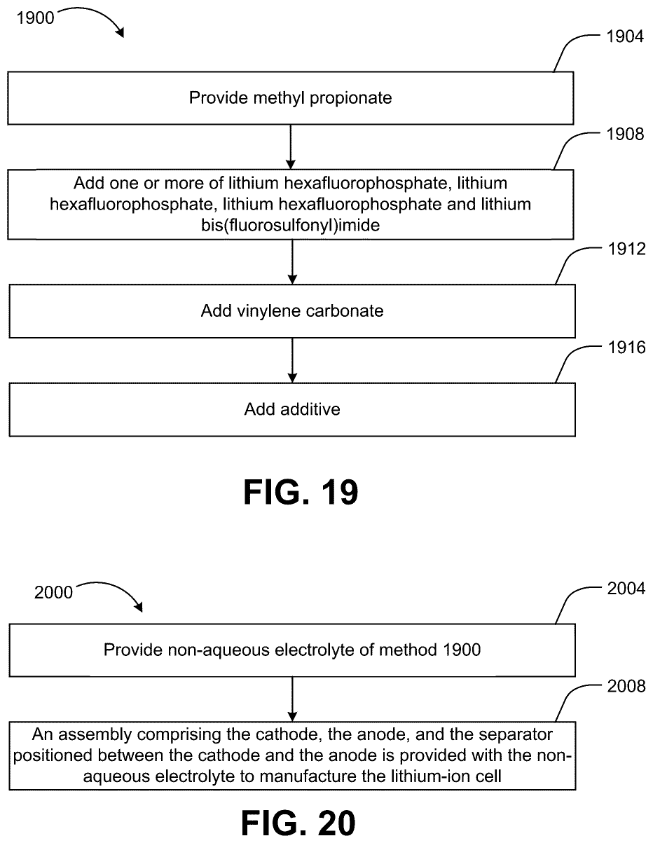

FIG. 19 illustrates a method 1900 for preparing the non-aqueous electrolytes according to aspects of the present disclosure.

At 1904, methyl propionate is provided.

At 1908, one or more of lithium hexafluorophosphate, lithium hexafluorophosphate, lithium hexafluorophosphate and lithium bis(fluorosulfonyl)imide is added.

At 1912, the vinylene carbonate is added. For example, about 2 wt % to about 15 wt % of vinylene carbonate may be added.

At 1916, the additive is added. About 1 wt % to about 5 wt % of the additive may be added. The additive includes lithium difluorophosphate, lithium difluoro(oxalate)borate, bis(oxalate)borate or a combination thereof.

Steps 1904-1916 may be done in any order, may be done simultaneously, or may be combined. Further any of steps 1908-1916 may be omitted.

FIG. 20 illustrates a method 2000 for preparing a lithium-ion cell, such as the cell 1800. At 2004, the non-aqueous electrolyte produced by the method 1900 is provided.

At 2008, an assembly comprising the cathode 1808, the anode 1812, and the separator 1816 positioned between the cathode 1808 and the anode 1812 is provided and combined with the non-aqueous electrolyte to manufacture the lithium-ion cell 1800.

Although FIGS. 19 and 20. 19 may show a specific order and composition of method steps, the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. All such modifications are intended to be included within the scope of the present disclosure as defined in the appended claims.

The above described and other features are exemplified by the following examples. In the examples, unless otherwise specified, the percent (%) of the components is the weight percent of the components in the non-aqueous electrolyte.

### EXAMPLES

The pouch cells used in Examples 1 to 15 and Comparative Examples 1-3 comprised a lithium nickel cobalt aluminum oxide (NCA) positive active material, graphite negative active material, and a microporous polypropylene separator. Each cell had an initial discharge capacity of about 32 milliampere-hours and included a double-sided cathode and two single sided anode electrodes. Each cell was filled with an 0.7 gram (g) of the non-aqueous electrolyte, which is in significant excess of the amount needed to fill the pore volume of the electrode stack. The cells were sealed under vacuum and restrained between flat plates prior to cycling.

As shown below in Table 1, the base electrolyte contained lithium hexafluorophosphate (LiPF6) or a combination of LiPF6 and lithium bis(fluorosulfonyl)imide (LiFSI) dissolved in methyl propionate (MP) or in a combination of MP and ethylene carbonate (EC). The concentration of the LiPF6 in the base electrolyte is 0.85 molar (M) or 0.10 M with 0.75 M LiFSI. Vinylene carbonate (VC) and the additives lithium difluorophosphate (LDFP), Lithium bis(oxalate)borate (LiBOB), and lithium difluoro(oxalate)borate (LiDFOB) were added to the base electrolyte to make the non-aqueous electrolytes of Examples 1 to 15. The compositions of the non-aqueous electrolytes of Examples 1 to 15 (Ex 1 to Ex 15) are summarized in Table 1, and the compositions of the non-aqueous electrolytes of Comparative Examples 1 to 5 (CEx 1 to CEx 5) are summarized in Table 2. The percent of VC and the additives LDFP, LiDFOB, and LiBOB added for these examples and comparative examples are shown as weight percentages.

TABLE 1

| | VC | LDFP | LiDFOB | LiBOB | Base |
|---|---|---|---|---|---|
| | (%) | (%) | (%) | (%) | Electrolyte |
| Ex 1* | 3.8 | 0 | 0 | 0 | 0.85 M LiPF₆ in MP |
| Ex 2 | 1.9 | 1.9 | 0 | 0 | 0.85 M LiPF₆ in MP |
| Ex 3 | 3.8 | 1.9 | 0 | 0 | 0.85 M LiPF₆ in MP |
| Ex 4 | 8.9 | 1.8 | 0 | 0 | 0.85 M LiPF₆ in MP |
| Ex 5 | 3.8 | 1 | 0 | 0 | 0.85 M LiPF₆ in MP |
| Ex 6 | 3.7 | 4.6 | 0 | 0 | 0.85 M LiPF₆ in MP |
| Ex 7 | 3.8 | 0.9 | 0.9 | 0 | 0.85 M LiPF₆ in MP |
| Ex 8 | 3.8 | 0 | 1.9 | 0 | 0.85 M LiPF₆ in MP |
| Ex 9 | 3.7 | 0 | 4.6 | 0 | 0.85 M LiPF₆ in MP |
| Ex 10 | 3.8 | 1.9 | 0 | 0.5 | 0.85 M LiPF₆ in MP |
| Ex 11 | 3.8 | 1.9 | 0 | 0 | 0.75 M LiFSI + |
| | | | | | 0.1 M LiPF₆ in MP |
| Ex 12 | 3.7 | 1.9 | 0 | 0.9 | 0.85 M LiPF₆ in MP |
| Ex 13 | 3.7 | 1.8 | 0 | 2.7 | 0.85 M LiPF₆ in MP |
| Ex 14 | 7.3 | 1.8 | 0 | 0 | 0.85 M LiPF₆ in MP |
| Ex 15 | 10.5 | 1.8 | 0 | 0 | 0.85 M LiPF₆ in MP |

*Ex 1 is a comparative example.

TABLE 2

| | VC | LDFP | LiBOB | Base |
|---|---|---|---|---|
| | (%) | (%) | (%) | Electrolyte |
| CEx 1 | 1.9 | 1.9 | 0 | 0.85 M LiPF₆ in |
| | | | | 1/1/1 EC/DMC/DEC |
| CEx 2 | 1.4 | 1.9 | 0.5 | 0.85 M LiPF₆ in |
| | | | | 22.5/20/27.5/30 |
| | | | | EC/DMC/EMC/MA |
| CEx 3 | 0 | 2.0 | 0 | 0.85 M LiPF₆ in MP |
| CEx 4 | 3.8 | 1.9 | 0 | 0.85 M LiPF₆ in 9/1 MP/EC |
| CEx 5 | 3.8 | 1.9 | 0 | 0.85 M LiPF₆ in 4/1 MP/EC |

The percentages shown in Table 2 refer to weight percentages.

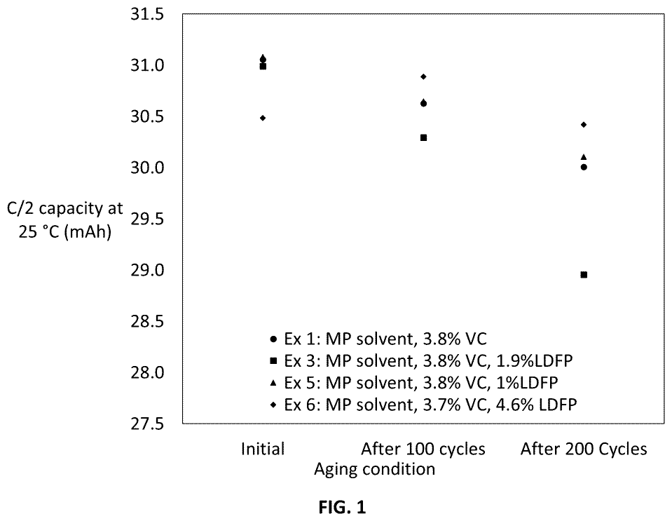

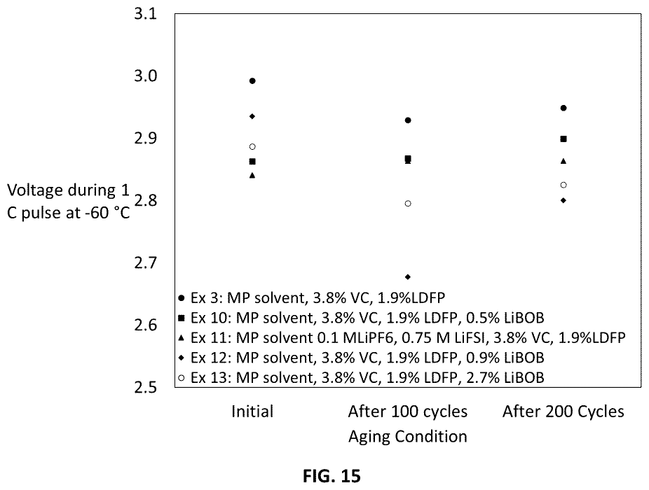

After formation of a cell including the non-aqueous electrolyte of Examples 1-15 or Comparative Examples CEx1-CEx 5, initial performance checks were made at 25° C. and at −60° C. These performance checks included a C/2 discharge capacity check at 25° C. and a C/4 capacity check at −60° C. Also, during the −0° C. discharge capacity check, a 1 second 1 C pulse was applied when the cell was at 95% state-of-charge (SOC), and the voltage was measured before and at the end of the pulse. Cells were aged by cycling cells between 3.0 and 4.1 V at 1 C rate at 25° C. with a constant voltage (CV) charge at 4.1 V until the current declined to C/20. Performance checks at 25° C. and −60° C. were performed again after 100 and 200 cycles. The results from these performance checks prior to cycling, after 100 cycles and after 200 cycles are shown in FIGS. 1-15. During the performance checks described herein, the cells were charged at 25° C. and discharged at 25° C. or −60° C., as noted in each figure. The “capacity” referred to in FIGS. 1-15 is the discharge capacity.

Table 3 shows the charge capacity, discharge capacity and Coulombic efficiency for a non-aqueous electrolyte that includes MP as the sole solvent with (Ex 1) and an electrolyte that does not include VC (CEx 3), an electrolyte with all organic carbonate solvents (CEx 1, which includes EC/DMC/DEC), and an electrolyte designed for high rate of discharge at temperatures as low as −40° C. that contains a high concentration of methyl acetate (MA) (CEx 2).

TABLE 3

| | Ex1 | CEx 1 | CEx 2 | CEx 3 |
|---|---|---|---|---|
| 1st Charge (mAh) | 39.4 | 38.5 | 39.6 | 58.0 |
| 1st Discharge (mAh) | 32.4 | 31.3 | 33.0 | 4.2 |
| Coulombic Efficiency (%) | 82.1 | 81.3 | 83.4 | 7.3 |
| % capacity at −60° C. of | 59.6 | 0.0 | 47.8 | NA |
| 25° C. discharge capacity | | | | |

$$Coulombic Efficiency = Discharge capacity / Charge capacity \times 100 \% \qquad Equation 1$$

With the exception of CEx 3, all of the electrolytes had good formation characteristics of high first charge and discharge capacities and Coulombic efficiency over 80% which is defined as in Equation 1. All of these samples other than CEx 3 had VC additive present, which is believed to aid in the formation of a solid-electrolyte interface (SEI) film that prevents the continued reduction of solvent at the anode. The presence of LDFP as the only additive in MP (without VC) was not enough to form an effective SEI, as indicated by the low discharge capacity of CEx 3 shown in Table 3. Without the ability to form an effective, stable SEI film, subsequent discharge can be very limited and the cell may not be able to cycle well, if at all. The charging process can also consume available lithium which further results in a lower discharge capacity, yielding a very low Coulombic efficiency relative to the examples that included VC.

Table 3 also shows the −60° C. performance of these different solvent systems. The non-aqueous electrolyte that includes MP as the sole solvent (Ex 1) has significantly higher discharge capacity at −60° C. compared to the other solvent systems. As shown with regard to CEx 1, cells with the non-aqueous electrolyte composed of a 1/1/1 EC/DMC/DEC organic carbonate mixture did not have any discharge capacity at −60° C., likely because the electrolyte froze and was no longer able to conduct lithium ions. The non-aqueous electrolyte used in CEx2 was designed for high-rate performance at temperatures as low as −40° C., and included 30% MA in the organic solvent mixture. However, as shown in Table 3, the non-aqueous electrolyte used in CEx2 had capacity that was 20% less than the non-aqueous electrolyte of Ex 1, which only includes MP as the solvent. The results show that using MP as the solvent can significantly improve the low temperature performance of the cells as compared to using organic carbonate mixtures or using organic solvents containing 30% MA.

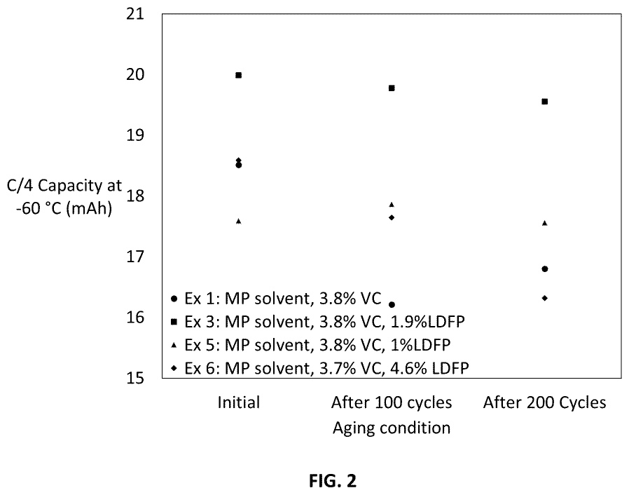

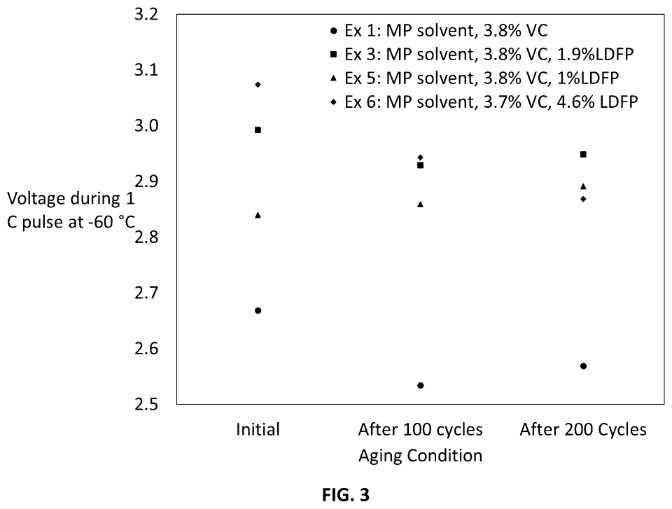

FIG. 1-3 show the effect of LDFP on the performance of non-aqueous electrolytes. Data from non-aqueous electrolytes formulated as described in Ex 1, 3, 5, and 6 are shown in FIGS. 1-3. Each of Ex 1, 3, 5, and 6 include MP and about 3.8% VC. Ex 1 is included as a comparative example that does not include LDFP. Examples 3, 5, and 6 include 1.9%, 1%, and 4.6% LDFP, respectively, with and other components of the non-aqueous electrolyte kept constant. FIG. 1 shows that the room temperature capacity for Ex 1 and Ex 5, which have low amounts of LDFP (0% and 1%, respectively) have similar initial discharge capacity and similar fade rate. As used herein, the phrase “discharge capacity fade rate” refers to the loss of discharge capacity as a cell undergoes multiple charge and discharge cycles. As shown in FIG. 1, at 1.9% LDFP (Ex 3), the room temperature discharge capacity fade rate is the highest out of the example electrolytes tested. At 4.6% LDFP (Ex 6) the capacity fade rate the lowest out of the examples tested, but the initial capacity of Ex 6 is also the least out of the examples tested. As shown in FIG. 3, at −60° C., Ex 3, which includes 1.9% LDFP, has the best discharge capacity and has the best capacity retention during aging out of the examples shown in FIG. 2, as indicated by the similar initial discharge capacity, discharge capacity after 100 cycles, and discharge capacity after 200 cycles. As shown in FIG. 2, at 1% LDFP (Ex 5) the initial discharge capacity is the lowest of the samples tested, but Ex 5′s retention of discharge capacity after aging is good, as indicated by the similar initial discharge capacity, discharge capacity after 100 cycles, and discharge capacity after 200 cycles. In contrast, as shown in FIG. 2, Ex 1, which does not include LDFP, showed poor retention of capacity after aging. For example, as shown in FIG. 2, the discharge capacity after 100 and 200 cycles is much lower than the initial discharge capacity. Ex 6 showed poor retention of capacity after 200 cycles of aging. At 0% and 4.6% LDFP (Ex 1 and Ex 6, respectively), the initial capacity is between that of 1-2% LDFP but the −60° C. capacity fade rate is higher. Therefore, non-aqueous electrolytes that include, 1-3%, preferably 1-2% of LDFP, can achieve superior performance at −60° in terms of capacity retention. In contrast, non-aqueous electrolytes that include no LDFP or 4.6% LDFP show poor performance in terms of capacity retention.

The voltage response during a 1 C pulse at −60° C. shown in FIG. 3 shows a similar trend as in FIG. 2 with the overall discharge capacity. While the initial voltage of Ex 6 with 4.6% LDFP is initially higher than those with less LDFP, the fade rate of Ex 6 is higher. Examples with 1-1.9% LDFP (Ex 3 and Ex 5) both have good voltage response and superior voltage fade rates at −60° C. relative to Ex 1, which did not include LDFP. As used herein, the phrase “voltage fade rate” refers to the decrease in voltage provided by the cell as a cell undergoes multiple charge and discharge cycles. Ex 1, which does not include LDFP, has the worst voltage response at −60° C. out of the examples tested. The results show that with 1-3%, preferably 1-2% of LDFP, the non-aqueous electrolytes can achieve excellent performance at −60° C. in terms of capacity retention.

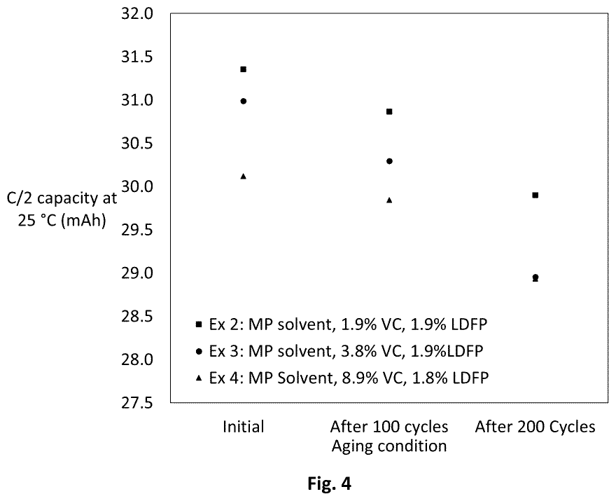

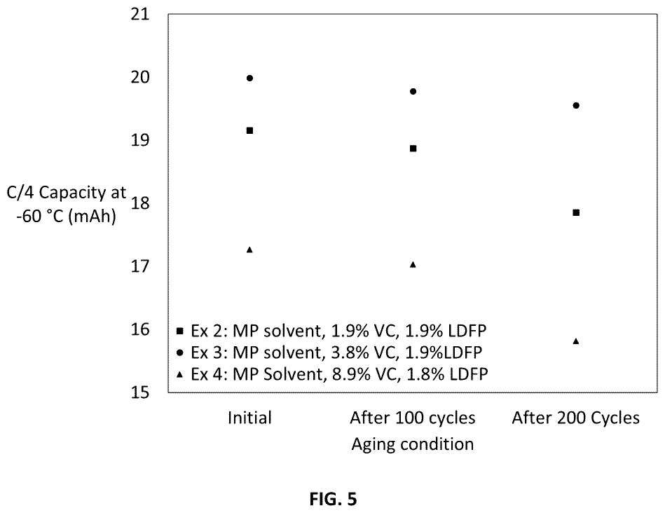

FIGS. 4-6 show the effect of the quantity of VC used in the non-aqueous electrolyte. FIGS. 4-6 show data from Ex 2-4, which include about 1.9% LDFP. As shown in FIG. 4, at 25° C., the room temperature discharge capacity of the cell increases with decreasing VC content from 8.9% to 1.9%. As shown in FIG. 5, at −60° C., cells with 3.8% VC (Ex 3) have the highest discharge capacity. The cells with 1.9% VC (Ex 2) have a higher discharge capacity than cells with 8.9% VC (Ex 4). The discharge capacity fade rate at −60° C. was best for the cells with 3.8% VC. The voltage response to a 1 C pulse at −60° C. shows that cells with 1.9% VC have a slightly better response than cells with 3.8% VC. The cells that include 3.8% VC have a much better response than cells with 8.9% VC. The results show that the non-aqueous cells having 4% VC to 2% VC have the best performance at −60° C.

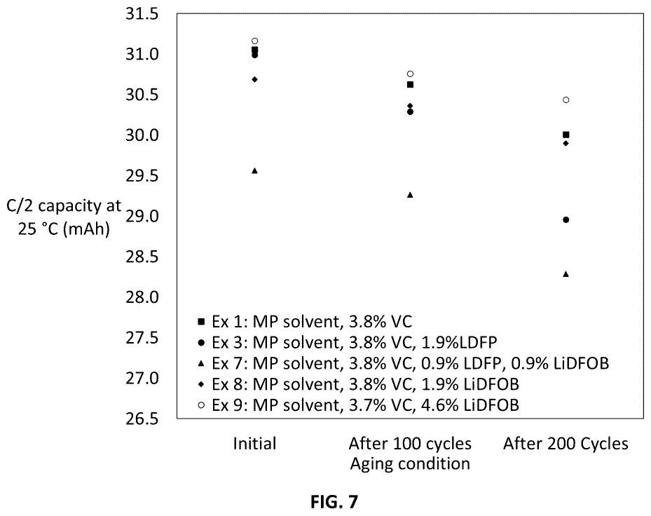

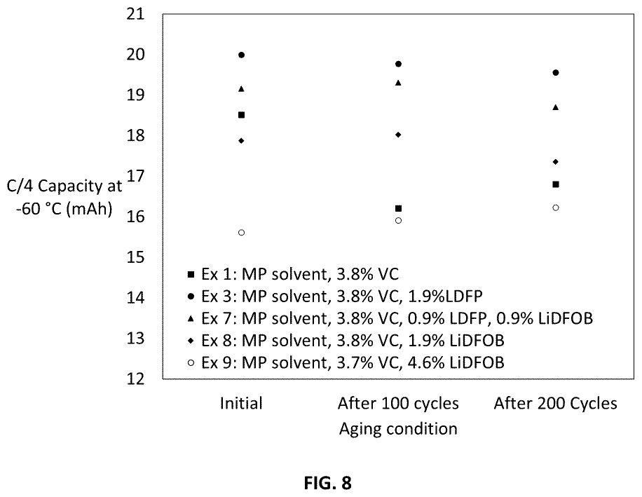

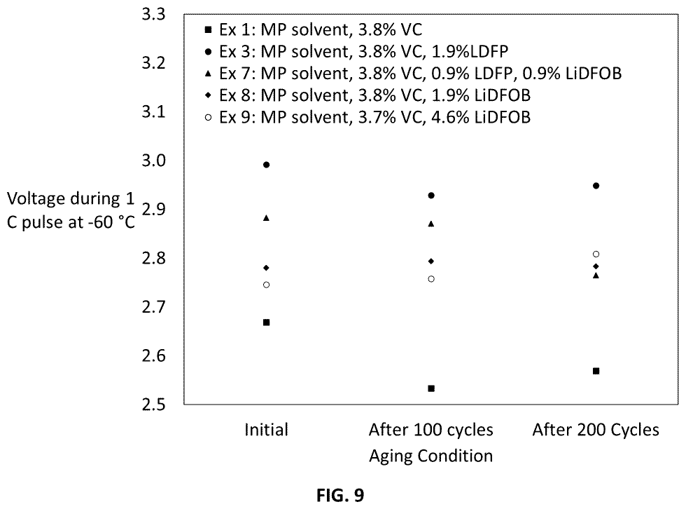

FIGS. 7-9 show the effect of LiDFOB to the non-aqueous electrolyte and a comparison of non-aqueous electrolytes including LiDFOB to non-aqueous electrolytes including LDFP. FIGS. 7-9 show data from non-aqueous electrolytes formulated as described in Ex 3 and Ex 7-9. FIGS. 7-9 also include data from the non-aqueous electrolyte formulated as described in Ex 1, which does not include LiDFOB or LDFP, as a comparative example. In Ex 1, 3, and 7-9, the amount of VC was kept constant at about 3.9%. As shown in FIG. 7, the room temperature discharge capacities of cells with LiDFOB (Ex 8 and Ex 9) are fairly similar to cells with no LiDFOB (Ex 1) at 25° C. As shown in FIG. 7, cells that had only VC and LiDFOB (Ex 8 and Ex 9) had better discharge capacity retention than cells had LDFP present with LiDFOB (Ex 7) or without LIDFOB (Ex 3). As shown in FIG. 8, the C/4 discharge capacity at −60° C. is highest for cells that have LDFP (Ex 3 and Ex 7). The discharge capacity retention for cell with 1.9% LiDFOB is better than cells with only VC (Ex 1). Cells with 4.6% LiDFOB had the lowest discharge capacity at −60° C. but the discharge capacity retention was good. The 1 C rate voltage response at −60° C. showed that cells with non-aqueous electrolyte containing LDFP (Ex 3 and Ex 7) had a superior voltage response as seen in FIG. 9. Cells with only LiDFOB and VC (Ex 8 and Ex 9) had good voltage retention but were lower than cells that include LDFP (with or without LIDFOB). Both examples (Ex 8 and Ex 9) with LiDFOB and VC had a better voltage response than cells with only VC (Ex 1) present.

To summarize, FIGS. 7-9 indicate that non-aqueous electrolytes that include additives including 1%-2% LDFP, 1% to 5% LiDFOB, or a combination thereof perform better than non-aqueous electrolytes that do not include these additives, such as, for example, the non-aqueous electrolyte of Ex1. As shown in FIGS. 7-9, LDFP is the preferred additive, for example because the examples including LDFP (Ex 3 and Ex 7) have the highest discharge capacities at −60° C. and the best discharge capacity retention at −-60° C. Further, Ex 3 and Ex 7 have the highest voltage response and the best voltage retention at 100 cycles at −60° C.

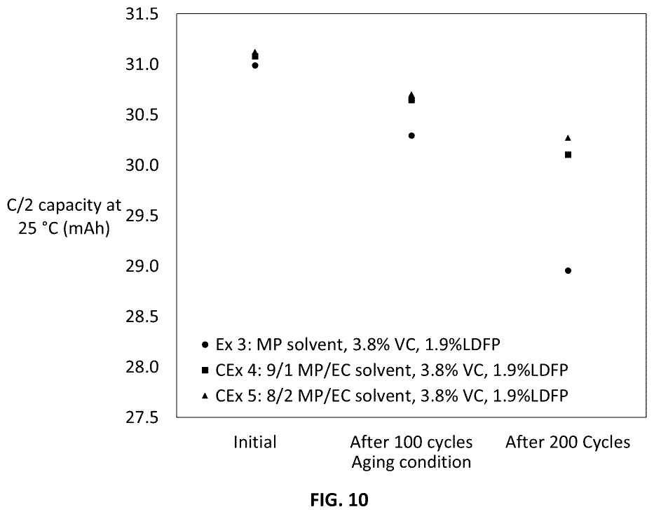

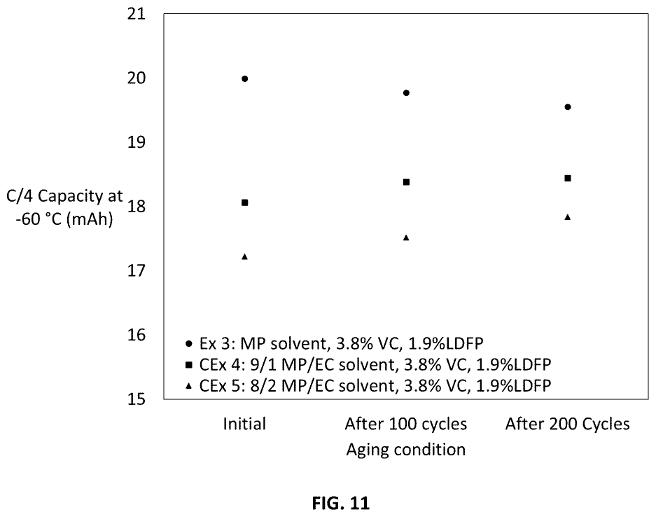

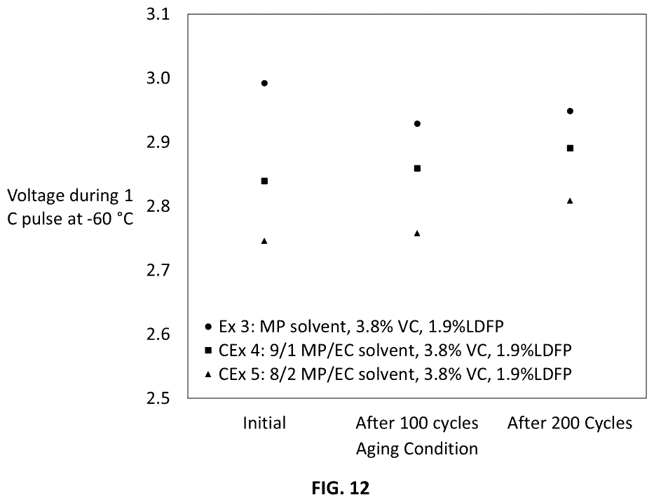

FIGS. 10-12 show the effect of EC in the non-aqueous electrolyte (CEx 4 and CEx5) and comparison to non-aqueous electrolyte with no EC present (Ex 3). At 25° C., the discharge capacity and discharge capacity retention of cells with EC in the non-aqueous electrolyte is superior to non-aqueous electrolyte with only MP as the non-aqueous electrolyte solvent as shown in FIG. 10, but the cells with only MP as the solvent still provided acceptable C/2 discharge capacity and discharge capacity retention. However, at −60° C., the discharge capacity of cells having EC in the non-aqueous electrolyte (CEx 4 and CEx 5) is less than the discharge capacity of the cells with MP (Ex 3) as the only solvent even after 200 cycles at room temperature as shown in FIG. 11. Furthermore, the discharge capacity of the cell declines with increasing EC content in the non-aqueous electrolyte. FIG. 12 shows that the end-of-pulse voltage during a 1 C pulse at −60° C. is lower for cells containing non-aqueous electrolytes with EC and that this voltage response becomes worse as the EC content is increased from 10% (Ex 10) to 20% (Ex 11) of the solvent in the non-aqueous electrolyte. Therefore, it is advantageous for the non-aqueous electrolyte not to include EC.

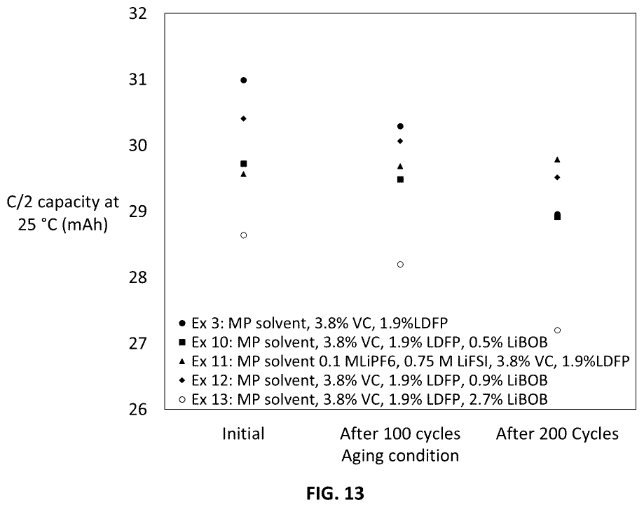

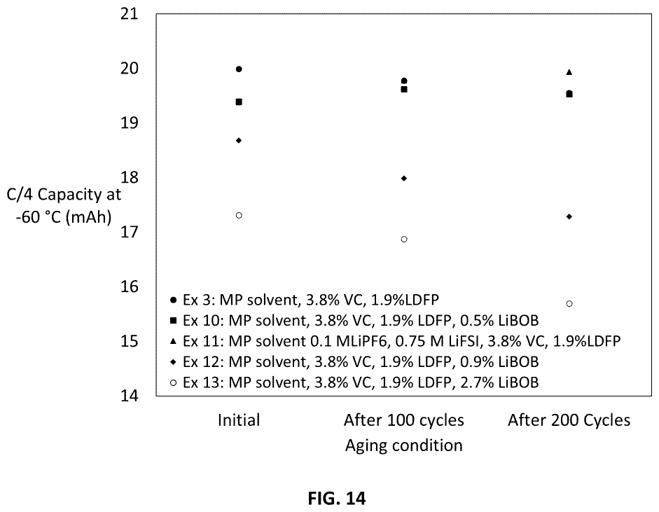

FIGS. 13-15 show a comparison of 0.85 M LiPF6 in MP with 4% VC and 1.9% LDFP (Ex 3), 0.85 M LiPF6 in MP with 4% VC, 1.9% LDFP, and 0.5, 0.9, and 2.7% LiBOB (Ex 10, 12, 13, respectively), and 0.1 M LiPF6/0.75 M LiFSI in MP with 4% VC and 1.9% LDFP (Ex 11). At room temperature as shown in FIG. 13, cells with 0.5 and 0.9% LiBOB (Ex 10, 12) and LiFSI (Ex 11) present have improved discharge capacity retention with regard to room temperature cycling compared to cells having the non-aqueous electrolyte of Ex 3. The −60° C. discharge capacity for cells with concentrations of LiBOB of 0.9% and higher is reduced and decreases with cycling at room temperature as seen in FIG. 14. At 0.5% LiBOB (Ex 10) the discharge capacity at −60° C. is similar to non-aqueous electrolyte with LiFSI (Ex 11), and the non-aqueous electrolyte with MP solvent and LiPF6 salt with only additives of LDFP and VC (Ex 3). The voltage response during the 1 C-rate pulse at −60° C. was the best for cells with the non-aqueous electrolyte of Ex 3 although the non-aqueous electrolyte with LiFSI (Ex 11) and 0.5% LiBOB (Ex 10) may have better stability.

The non-aqueous electrolyte's performance in 18650 cylindrical cells was also evaluated. In a first batch of 18650 cells employing NCA as the cathode and graphite as the anode, non-aqueous electrolytes of Examples 2 and 3 were tested, which had 1.9% and 3.8% of VC, respectively. Cells were filled with about 5.2 g of non-aqueous electrolyte. Cells with neither non-aqueous electrolyte formed well. When the cells were crimped closed after filling, cells with both non-aqueous electrolytes failed to form because the current interrupt device (CID) was triggered due to excessive gas formation. When the cell cover was not crimped and formation was performed, cells with 3.8% VC (Ex 3) had an average first cycle Coulombic efficiency of 62.3% while cells with 1.9% VC (Ex 2) had a Coulombic efficiency of 19.0%. Both of these Coulombic efficiencies are significantly lower than the corresponding efficiencies of 83.2 and 82.6% with the same non-aqueous electrolytes obtained in the 32 mAh pouch cells. The low Coulombic efficiency leads to significantly lower capacity than the expected 2500 mAh with cells having non-aqueous electrolyte containing 4% VC having an average capacity of 2059 mAh and those with 2% VC having an average capacity of 667 mAh.

A second batch of dry commercial off the shelf 18650 cylindrical cells consisting of NMC cathode and artificial graphite anodes were filled with three different non-aqueous electrolytes. The non-aqueous electrolytes consisted of 0.85 M LiPF6 in MP with 1.8% LDFP and 7.3% (Ex 14), 8.9% (Ex 4), or 10.5% VC (Ex 15), respectively. Each of the cells were filled with about 3.2 g of non-aqueous electrolyte. The first cycle Coulombic efficiency for cells with all three of these non-aqueous electrolytes was about 87.5% and met the expected capacity of about 2.07 Ah showing the cells were well passivated.

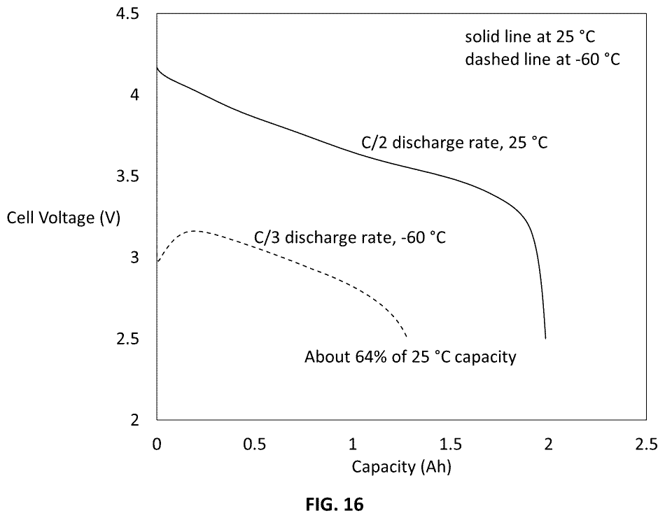

A third batch of 18650 cylindrical cells was prepared using NCA cathodes and graphite anodes. The cells were filled with about 4.3 g of non-aqueous electrolyte of Ex 4. The cells had an average Coulombic efficiency of 82.5% and an average capacity of 1.96 Ah which were within expectations for good formation and passivation for these electrodes. FIG. 16 shows the average voltage profile for three cells filled with non-aqueous electrolyte of Ex 4. A solid line is used to show discharge at a rate of C/2 at 25° C. Dashed lines are used to show discharge at a rate of C/3 at −60° C. At −60° C., the voltage initially drops to about 3.0V and then recovers somewhat as the cell undergoes self-heating and ultimately delivers about 64% of the capacity delivered at 25° C. and a rate of C/2.

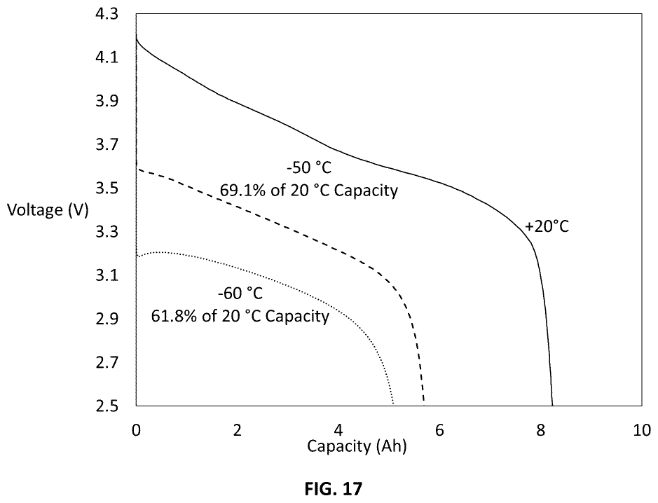

8 Ah cells were prepared using NCA cathodes and graphite anodes. The cells were filled with about 25 g of the non-aqueous electrolyte of Ex 3 and Ex 4. The cells had an average capacity of 8.04 and 7.89 Ah (voltage range 4.1 to 3.0 V) respectively. The first cycle coulombic efficiency was above 85% for both non-aqueous electrolytes and over 99.5% after the second cycle indicating that the cells had good formation characteristics and the electrode were passivated. FIG. 17 shows the C/4 (2 A) voltage profile from 4.2 to 2.5 V for the 8 Ah cells with non-aqueous electrolyte of Ex 3 having 3.8% VC at 20° C., −50° C., and −60° C. Cells with the non-aqueous electrolyte of Ex 4 having 8.9% VC did not have any appreciable capacity at the C/4 discharge rate at −50° C. or −60° C.

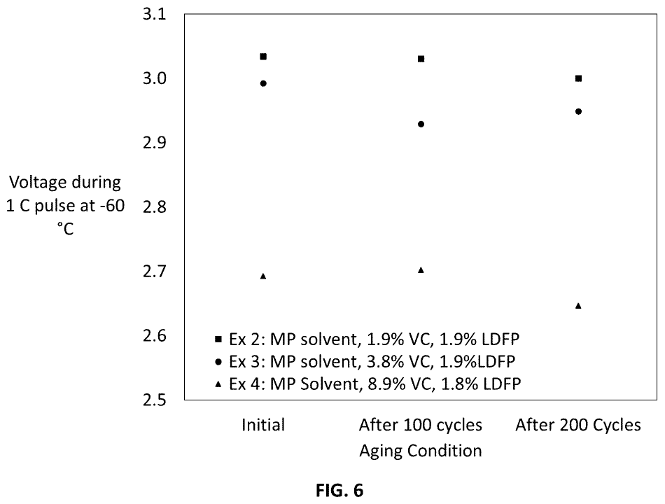

There is a distinct difference between the first cycle efficiency (FCE) of cells even with the same non-aqueous electrolytes and is summarized in Table 4 below. Table 4 shows the non-aqueous electrolytes in various cell formats and ratio of g of VC to initial discharge capacity. For all non-aqueous electrolytes, the percentage of LDFP in the non-aqueous electrolyte was kept relatively constant at 1.8-1.9 wt % of the non-aqueous electrolyte. As can be seen in Table 4, pouch cells including the non-aqueous electrolyte formulated as described in examples Ex 2-Ex 4 achieve a high first cycle FCE with non-aqueous electrolytes having less VC than 18650 cells. The 18650 cells with lower amounts of VC (Ex 2, Ex 3) in the first batch of 18650 cells unexpectedly had a low FCE and also generated enough gas to activate the CID. These results are consistent with poor passivation of the anode of the cell wherein a passivation layer is believed to be formed at the interface between the anode and the non-aqueous electrolyte. The passivation layer is what allows the battery to function; the passivation layer allows for lithium ion transfer from the non-aqueous electrolyte to the anode but prevents electron transfer to the non-aqueous electrolyte where electron transfer could continue to further reduce the non-aqueous electrolyte. These results prompted the evaluation of non-aqueous electrolytes with higher concentrations of VC that did not perform very well in 32 mAh pouch cells in 18650 cells. As Table 4 shows, 18650 cells with higher concentrations of VC in the non-aqueous electrolyte do have high Coulombic efficiency indicating proper passivation. The cells also have stable capacity with further cycling which is a further indicator of passivation. It is believed that the reason the pouch cells with a lower VC concentration were able to have proper passivation while the 18650 cells did not is because the pouch cells had a high VC content relative to the surface area of the electrodes. Table 4 shows the ratio of grams of VC to the cell discharge capacity, which provides a rough correlation to electrode surface area. From Table 4, when the ratio of grams of VC to initial capacity (Ah) is less than about 0.1 g VC to 1 ampere-hour (Ex 2 and Ex 3 of the 1st batch of 18650 cells), the cells are not able to have good formation and passivation as demonstrated by the FCE being at 19 and 62%. With a gram of VC to capacity ratio above about 0.1 g VC to 1 ampere-hour (2^{nd} and 3^{rd} batch of 18650 cells with Ex 4, 14, 15) the cells have good first cycle FCE and have a good formation as demonstrated by FCE values above 80%. Too much VC though can hurt low temperature performance as seen in FIG. 5 and FIG. 6. It is therefore preferable that the g of VC to initial capacity ratio be between about 0.1 g VC to one ampere-hour to about 1 g VC to 1 ampere-hour.

TABLE 4

| | | | electrolyte | Capacity | ratio | FCE |
|---|---|---|---|---|---|---|
| Cell type, batch | Electrolyte | % VC | (g) | (Ah) | g VC/Ah | (%) |
| single layer | Example 2 | 1.9 | 0.7 | 0.032 | 0.416 | 82.6 |
| pouch cells | Example 3 | 3.8 | 0.7 | 0.032 | 0.831 | 83.3 |
| | Example 4 | 8.9 | 0.7 | 0.032 | 1.947 | 81.2 |
| 18650 cell, 1st | Example 2 | 1.9 | 5.2 | 2.5 | 0.040 | 19 |
| batch | Example 3 | 3.8 | 5.2 | 2.5 | 0.079 | 62.3 |
| 18650 cell, 2nd | Example 14 | 7.3 | 3.2 | 2.07 | 0.113 | 87.5 |
| batch | Example 4 | 8.9 | 3.2 | 2.07 | 0.138 | 87.5 |
| | Example 15 | 10.5 | 3.2 | 2.07 | 0.162 | 87.5 |
| 18650 cells, | Example 4 | 8.9 | 4.3 | 1.96 | 0.195 | 82.5 |
| 3rd batch | | | | | | |
| 8 Ah Pouch cells | Example 3 | 3.8 | 25 | 8.04 | 0.118 | 85.9 |
| 8 Ah Pouch cells | Example 4 | 8.9 | 25 | 7.89 | 0.284 | 85.4 |

The compositions, methods, and articles can comprise any appropriate materials, steps, or components herein disclosed. The compositions, methods, and articles can consist of any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

It will be understood that when an element is referred to as being “on” another element, it can be directly on the other element or intervening elements may be present therebetween. In contrast, when an element is referred to as being “directly on” another element, there are no intervening elements present.

Set forth below are various aspects of the disclosure.

Thus, one of more aspects of the present disclosure may be implemented according to one or more of the following clauses.

Clause 1. A non-aqueous electrolyte for a lithium-ion cell, comprising: a base electrolyte consisting of lithium hexafluorophosphate or lithium bis(fluorosulfonyl)imide or a combination thereof in methyl propionate; about 2 to about 15 wt % of vinylene carbonate; and about 0.5 to about 5 wt % of an additive comprising lithium difluorophosphate, lithium difluoro(oxalate)borate, lithium bis(oxalate)borate, or a combination thereof.

Clause 2. The non-aqueous electrolyte of clause 1, wherein an amount of the vinylene carbonate in grams in the non-aqueous electrolyte relative to an initial discharge capacity of the lithium-ion cell that comprises the non-aqueous electrolyte in ampere-hour is between about 0.1 and about 1.

Clause 3. The non-aqueous electrolyte of any one of clauses 1-2, comprising less than about 5 wt % of ethylene carbonate.

Clause 4. The non-aqueous electrolyte of any one of clauses 1-3, wherein the non-aqueous electrolyte is substantially free from ethylene carbonate.

Clause 5. The non-aqueous electrolyte of any one of clauses 1-4, wherein the non-aqueous electrolyte comprises about 3 wt % to about 10 wt % parts by weight of the vinylene carbonate.

Clause 6. The non-aqueous electrolyte any one of clauses 1-5, wherein the lithium hexafluorophosphate is present in an amount of about 0.3 to about 1.5 mole/liter in the base electrolyte.

Clause 7. The non-aqueous electrolyte of clause 1, consisting of: the base electrolyte consisting the lithium salts consisting of hexafluorophosphate or a lithium hexafluorophosphate and lithium bis(fluorosulfonyl)imide mixture whose total combined concentration is about 0.3 to about 1.5 mole/liter dissolved in methyl propionate; about 2 wt % to about 15 wt %, preferably about 3 wt % to about 10 wt % vinylene carbonate; and about 1 wt % to about 5 wt %, preferably about 2 wt % to about 5 wt % of the additive consisting of lithium difluorophosphate, lithium difluoro(oxalate)borate, or a combination thereof.

Clause 8. The non-aqueous electrolyte of clause 7, wherein the non-aqueous electrolyte comprises about 2 wt % to about 12 wt % of the vinylene carbonate.

Clause 9. A lithium-ion cell comprising: a positive electrode; a negative electrode; a separator interposed between the positive electrode and the negative electrode; and a non-aqueous electrolyte comprising: a base electrolyte consisting of lithium hexafluorophosphate or lithium hexafluorophosphate and lithium bis(fluorosulfonyl)imide mixture dissolved in methyl propionate; about 2 wt % to about 15 wt % of vinylene carbonate; and about 0.5 wt % to about 5 wt % of an additive comprising lithium difluorophosphate, lithium difluoro(oxalate)borate, lithium bis(oxalate)borate or a combination thereof.

Clause 10. The lithium-ion cell of clause 9, wherein a ratio of an amount of the vinylene carbonate in grams (g) in the non-aqueous electrolyte relative to an initial discharge capacity of the lithium-ion cell in ampere-hour is between about 0.1 g vinylene carbonate to 1 ampere-hour and about 1 g vinylene carbonate to 1 ampere-hour.

Clause 11. The lithium-ion cell of any one of clauses 9-10, wherein the non-aqueous electrolyte comprises less than about 5 wt % of ethylene carbonate based on the total weight of the base electrolyte, the vinylene carbonate, and the additive.

Clause 12. The lithium-ion cell of any one of clauses 9-11, wherein the non-aqueous electrolyte is free of ethylene carbonate.

Clause 13. The lithium-ion cell of any one of clauses 9-12 wherein the lithium hexafluorophosphate and lithium hexafluorophosphate and lithium bis(fluorosulfonyl)imide mixture whose total combined concentration is present in an amount of about 0.3 to about 1.5 mole/liter in the base electrolyte.

Clause 14. The lithium-ion cell of clause 9, wherein the non-aqueous electrolyte consists of: the base electrolyte consisting of the lithium salts consisting of (1) hexafluorophosphate or a lithium hexafluorophosphate and (2) lithium bis(fluorosulfonyl)imide mixture where a total combined concentration of (1) and (2) is about 0.3 to about 1.5 mole/liter dissolved in methyl propionate; about 2 wt % to about 15 wt % of vinylene carbonate; and about 0.5 wt % to about 5 wt % of the additive consisting of lithium difluorophosphate, lithium difluoro(oxalate)borate, lithium bis(oxalate)borate or a combination thereof.

Clause 15. A method of preparing a non-aqueous electrolyte, the method comprising: providing a base electrolyte consisting of lithium hexafluorophosphate or lithium hexafluorophosphate and lithium bis(fluorosulfonyl)imide mixture dissolved in methyl propionate; combining the base electrolyte with about 2 wt % to about 15 wt % of vinylene carbonate and about 1 wt % to about 5 wt % of an additive to prepare the non-aqueous electrolyte, the additive comprising lithium difluorophosphate, lithium difluoro(oxalate)borate, bis(oxalate)borate or a combination thereof.

Clause 16. The method of clause 15, wherein the non-aqueous electrolyte consists of: the base electrolyte consisting the lithium salts consisting of hexafluorophosphate or a lithium hexafluorophosphate and lithium bis(fluorosulfonyl)imide mixture whose total combined concentration is about 0.3 to about 1.5 mole/liter dissolved in methyl propionate; about 2 wt % to about 15 wt % of vinylene carbonate; about 1 wt % to about 5 wt % of the additive consisting of lithium difluorophosphate, lithium difluoro(oxalate)borate, or a combination thereof.

Clause 17. A method of manufacturing a lithium-ion cell, the method comprising: providing the non-aqueous electrolyte of clause 1; and adding the non-aqueous electrolyte to an assembly comprising a cathode, an anode, and a separator between the cathode and the anode to manufacture the lithium-ion cell.

Clause 18. The method of clause 17, wherein a ratio of an amount of the vinylene carbonate in grams (g) in the non-aqueous electrolyte relative to an initial discharge capacity of a cell that comprises the non-aqueous electrolyte in ampere-hour is between about 0.1 g vinylene carbonate to 1 ampere-hour and about 1 g vinylene carbonate to 1 ampere-hour.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A non-aqueous electrolyte for a lithium-ion cell, comprising:
a base electrolyte consisting of lithium hexafluorophosphate or lithium bis(fluorosulfonyl)imide or a combination thereof in methyl propionate;
about 2 to about 15 wt % of vinylene carbonate; and
about 0.5 to about 5 wt % of an additive comprising lithium difluorophosphate, lithium difluoro(oxalate)borate, lithium bis(oxalate)borate, or a combination thereof.

2. The non-aqueous electrolyte of claim 1, wherein an amount of the vinylene carbonate in grams in the non-aqueous electrolyte relative to an initial discharge capacity of the lithium-ion cell that comprises the non-aqueous electrolyte in ampere-hour is between about 0.1 and about 1.

3. The non-aqueous electrolyte of claim 1, comprising less than about 5 wt % of ethylene carbonate.

4. The non-aqueous electrolyte of claim 1, wherein the non-aqueous electrolyte is substantially free from ethylene carbonate.

5. The non-aqueous electrolyte of claim 1, wherein the non-aqueous electrolyte comprises about 3 wt % to about 10 wt % parts by weight of the vinylene carbonate.

6. The non-aqueous electrolyte of claim 1, wherein the lithium hexafluorophosphate is present in an amount of about 0.3 to about 1.5 mole/liter in the base electrolyte.

7. The non-aqueous electrolyte of claim 1, consisting of:
the base electrolyte consisting the lithium salts consisting of hexafluorophosphate or a lithium hexafluorophosphate and lithium bis(fluorosulfonyl)imide mixture whose total combined concentration is about 0.3 to about 1.5 mole/liter dissolved in methyl propionate;
about 2 wt % to about 15 wt % vinylene carbonate; and
about 1 wt % to about 5 wt % of the additive consisting of lithium difluorophosphate, lithium difluoro(oxalate)borate, or a combination thereof.

8. The non-aqueous electrolyte of claim 7, wherein the non-aqueous electrolyte comprises about 2 wt % to about 12 wt % of the vinylene carbonate.

9. A lithium-ion cell comprising:
a positive electrode;
a negative electrode;
a separator interposed between the positive electrode and the negative electrode; and
a non-aqueous electrolyte comprising:
a base electrolyte consisting of lithium hexafluorophosphate or lithium hexafluorophosphate and lithium bis(fluorosulfonyl)imide mixture dissolved in methyl propionate;
about 2 wt % to about 15 wt % of vinylene carbonate; and
about 0.5 wt % to about 5 wt % of an additive comprising lithium difluorophosphate, lithium difluoro(oxalate)borate, lithium bis(oxalate)borate or a combination thereof.

10. The lithium-ion cell of claim 9, wherein a ratio of an amount of the vinylene carbonate in grams (g) in the non-aqueous electrolyte relative to an initial discharge capacity of the lithium-ion cell in ampere-hour is between about 0.1 g vinylene carbonate to 1 ampere-hour and about 1 g vinylene carbonate to 1 ampere-hour.

11. The lithium-ion cell of claim 9, wherein the non-aqueous electrolyte comprises less than about 5 wt % of ethylene carbonate based on the total weight of the base electrolyte, the vinylene carbonate, and the additive.

12. The lithium-ion cell of claim 9, wherein the non-aqueous electrolyte is free of ethylene carbonate.

13. The lithium-ion cell of claim 9, wherein the lithium hexafluorophosphate and lithium hexafluorophosphate and lithium bis(fluorosulfonyl)imide mixture whose total combined concentration is present in an amount of about 0.3 to about 1.5 mole/liter in the base electrolyte.

14. The lithium-ion cell of claim 9, wherein the non-aqueous electrolyte consists of:
the base electrolyte consisting of the lithium salts consisting of (1) hexafluorophosphate or a lithium hexafluorophosphate and (2) lithium bis(fluorosulfonyl)imide mixture where a total combined concentration of (1) and (2) is about 0.3 to about 1.5 mole/liter dissolved in methyl propionate;
about 2 wt % to about 15 wt % of vinylene carbonate; and
about 0.5 wt % to about 5 wt % of the additive consisting of lithium difluorophosphate, lithium difluoro(oxalate)borate, lithium bis(oxalate)borate or a combination thereof.

15. A method of preparing a non-aqueous electrolyte, the method comprising:
providing a base electrolyte consisting of lithium hexafluorophosphate or lithium hexafluorophosphate and lithium bis(fluorosulfonyl)imide mixture dissolved in methyl propionate;
combining the base electrolyte with about 2 wt % to about 15 wt % of vinylene carbonate and about 1 wt % to about 5 wt % of an additive to prepare the non-aqueous electrolyte, the additive comprising lithium difluorophosphate, lithium difluoro(oxalate)borate, bis(oxalate)borate or a combination thereof.

16. The method of claim 15, wherein the non-aqueous electrolyte consists of:
the base electrolyte consisting the lithium salts consisting of hexafluorophosphate or a lithium hexafluorophosphate and lithium bis(fluorosulfonyl)imide mixture whose total combined concentration is about 0.3 to about 1.5 mole/liter dissolved in methyl propionate;
about 2 wt % to about 15 wt % of vinylene carbonate;
about 1 wt % to about 5 wt % of the additive consisting of lithium difluorophosphate, lithium difluoro(oxalate)borate, or a combination thereof.

17. A method of manufacturing a lithium-ion cell, the method comprising:
providing the non-aqueous electrolyte of claim 1; and
adding the non-aqueous electrolyte to an assembly comprising a cathode, an anode, and a separator between the cathode and the anode to manufacture the lithium-ion cell.

18. The method of claim 17, wherein a ratio of an amount of the vinylene carbonate in grams (g) in the non-aqueous electrolyte relative to an initial discharge capacity of a cell that comprises the non-aqueous electrolyte in ampere-hour is between about 0.1 g vinylene carbonate to 1 ampere-hour and about 1 g vinylene carbonate to 1 ampere-hour.
